(19) United States
(12) Patent Application Publication
(10) Pub. No.: US 2016/0135235 A1
(43) Pub. Date: May 12, 2016

(54) SYSTEM AND METHOD FOR INFORMATION SHARING BASED ON WIRELESS ASSOCIATION

(71) Applicant: David R. ELMALEH, Newton, MA (US)

(72) Inventor: David R. ELMALEH, Newton, MA (US)

(21) Appl. No.: 14/534,325

(22) Filed: Nov. 6, 2014

(51) Int. Cl. H04W 76/02; H04W 8/24; H04W 72/10

(52) U.S. Cl. CPC H04W 76/021; H04W 72/10; H04W 8/24; H04W 88/08

(57) ABSTRACT

In a communication network comprising a plurality of user equipment (“UEs”) supported by one or more wireless access points (“APs”), identification data for a user of first UE is received, for example at a computing device or another UE in the network, for example in a packet. A unique identifier of an access point AP serving the first UE is also received, optionally in the same packet as the user identification data. A unique identifier of an access point AP serving a second UE is received, for example in a packet from the second UE. If the unique identifiers meet at least one predetermined criterion, e.g. they match, permission may be granted for the identification data for the user of the first UE to be transmitted to the second UE.

### FIELD OF THE INVENTION

The present invention relates generally to the field of wireless communication.

### BACKGROUND OF THE INVENTION

Prior to a detailed discussion of embodiments of the invention being set out, the following definition of terms used in the description is provided:

Access Point, abbreviated to AP, defines a device that allows wireless devices to connect to a wired network. An AP may connect to a router as a standalone device or it may include a router or be an integral component of a router. An AP is generally said to “serve” the devices that it allows to connect to the wired network and those devices are said to be “associated” with the AP.

Basic Service Set, BSS, is a set of devices associated with a wireless network, such as a cluster of user equipment, associated with an AP.

The term Station or STA is a term used for any participant on a network and may include APs and user equipment.

Media access control or MAC refers to a communication protocol that makes it possible for several STAs to communicate within a network.

Media access control address or MAC address is a unique identifier assigned to network interfaces.

Mobile Broadband Wireless Access or MBWA refers to technology that allows communication devices to interact wirelessly based on the Institute of Electrical and Electronics Engineers (IEEE) 802.20 Standard.

Each BSS is identified by a service set identifier or SSID. This may be the MAC address of the AP.

User Equipment or UE, is a term used to refer to a wireless device, for example a device that connects to a wired network via an AP. A UE may comprise a mobile communication device such as but not limited to a phone, tablet computing device, or personal (e.g. laptop) computer.

Wi-Fi refers to technology that allows communication devices to interact wirelessly based on the IEEE 802.11 Standard.

WiMAX refers to technology that allows communication devices to interact wirelessly based on the IEEE 802.16 Standard.

Interactions between UEs and APs may be via MBWA, Wi-Fi, WiMAX, LTE or any other wireless technology or protocol. Thus embodiments of the invention are not limited to systems and methods using complying with the IEEE specifications. However embodiments of the invention may be implemented in communication systems including UEs served by a wireless network complying with any of the 802.11, 802.16 and 802.20 specifications.

There is a need for a way to provide wireless access to data, voice or video to devices that are in association with an access point or basic service set.

### SUMMARY OF THE INVENTION

Some embodiments of this invention may comprise methods, apparatus and systems that may be used to facilitate communication between users of equipment such as mobile communication devices, based on their location or proximity to certain equipment. For users of wireless networks their location may be approximated based on which wireless AP is serving them or based on the AP to which and from which they may be sending or receiving packets. Some embodiments of the invention permit the sharing of user information between users of mobile communication devices or the associating of UE's based on a unique identifier identifying the AP used by devices. This sharing of information by electronic communication may facilitate subsequent personal or face to face communication between users. Other embodiments of the invention permit the sharing of other information among a group of users, for example to facilitate a discussion, based on their location. Again the location may be determined by proximity or receipt of packets from one or more AP's. The information may be in any format. According to some embodiments of the invention, the information comprises data, text, voice, pictures or videos. The information can be presented on receiving devices in one or multiple formats. According to some embodiments of the invention, a UE user may be provided with a choice of formats, for example as thumbnail icons, from which to choose for example depending on UE type.

Some embodiments of this invention may comprise a method implemented in a communication network comprising a more than one UE's supported by one or more wireless access points “APs”. The UEs and APs may communicate with each other in a wireless network, using Wi-Fi or other wireless protocol for example. Some operations of methods, according to some embodiments of the invention, may be implemented in one or more computing devices, such as servers, gateways, routers or other processors, which may be located outside the wireless network that connects the UEs and APs.

Methods according to some embodiments of the invention may be used to convey or transmit information between UE users, for example UE user identification data. Such methods, according to some embodiments of the invention, may include accepting or receiving identification data for a user of first user equipment “UE”, for example in a predetermined format. A non-limiting example of user identification data is a completed conference registration form. Some embodiments may further include receiving a unique identifier of an access point “AP” serving the first UE and a unique identifier of an access point “AP” serving the second UE. The identifiers may be examined and it may be decided or determined that the unique identifiers meet at least one predetermined criterion, in which case permission may be granted for the identification data for the user of the first UE to be sent to the second UE or for the two UE's to associate and share data without a need for the data to be addressed specifically to the UE.

An apparatus according to embodiments of the invention may include a computing device configured to implement one or more of the methods described herein according to some embodiments of the invention. A system according to some embodiments of the invention may comprise a wireless communication network comprising a more than one user equipment “UEs” supported by one or more wireless access points “APs”. Such a system may comprise at least one computing device. At least one AP may be configured to route or copy packets received from supported UEs to another UE served by the same AP or a UE or computing device outside the wireless communication network.

In the following “sending” of information or data from one device, e.g. computing device, to another may comprise the generation of a packet containing that information or data addressed to the other device and may include the transmission of the packet, typically wirelessly. “Sending” of information or data may also comprise delivering of the information or data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Some embodiments of the invention are illustrated by way of example and not limitation in the figures of the accompanying drawings, in which like reference numerals indicate corresponding, analogous or similar elements, and in which:

FIG. 1 is a schematic diagram of a wireless communications system according to some embodiments of the invention;

FIG. 2 is a diagram of a MAC frame format from the 802.11 Standard as used in some embodiments of the invention;

FIGS. 3A and 3B are flow charts illustrating methods according to some embodiments of the invention;

FIG. 4 is a flow chart illustrating methods according to some embodiments of the invention;

FIG. 5 is a basic schematic diagram showing components of an AP according to some embodiments of the invention; and

FIG. 6 is a basic schematic diagram showing components of a computing device according to some embodiments of the invention.

### DETAILED DESCRIPTION OF THE INVENTION

In the following detailed description, numerous specific details are set forth in order to provide a thorough understanding of embodiments of the invention. However, it will be understood by those of ordinary skill in the art that some embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “comparing”, “designating,” “allocating” “compiling a list”, “assemble a table” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Some embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions, upon execution by for example a processor or group of processors, result in a method of an embodiment of the invention.

As used in this application, the terms “supported”, “associated with” or “served by” may, in addition to their regular meanings, mean that one device is exchanging data packets, such as wirelessly, with another device, and through such exchange of packets, the first device is gaining access to a network. For example, an UE may be supported by, in association with or served by one or more AP's, when the UE is sending to and receiving packets from the AP such that for example the UE is gaining access to a network or other devices by way of such packets.

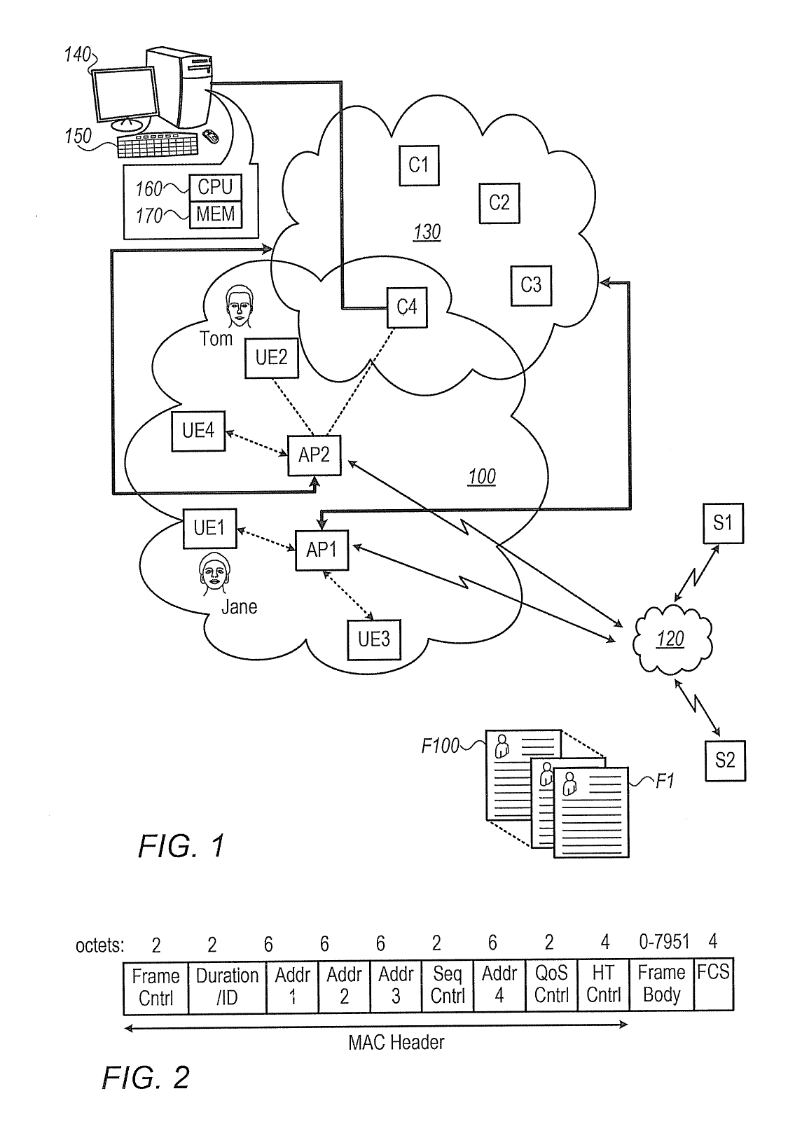

FIG. 1 shows some components of a basic communication system in which some embodiments of the invention may be implemented. The communication system shown in FIG. 1 includes a wireless network 100, e.g. Wi-Fi, WiMAX, MBWA or any other wireless protocol. A wireless network such as network 100 may be used in a wide variety of applications including but not limited to buildings, airports, university campuses, cities and other geographical areas of various sizes. FIG. 1 shows for simplicity and clarity an example of wireless network including two APs, AP1 and AP2, serving respective UEs. As shown UE1 and UE3 are served by AP1 while UE2 and UE4 are served by AP2. Dotted lines in FIG. 1 represent wireless connections or links. UEs may comprise mobile communication devices. As UEs are moved around the area served by AP1 and AP2, one UE, e.g. UE1, may cease being served by AP1 and commence being served by AP2. In other embodiments, the number of APs may be one or many more than two and the number of UEs served by each AP may be many more than two.

UEs may use the wireless network 100 to access the internet 120, for example, for the purpose of obtaining information from one or more remote servers, e.g., S1 and S2. The communication links between APs, AP1 and AP2, and the internet 120, for example to access remote servers S1 and S2, may use a combination of wired and wireless technology. Solid lines in FIG. 1 represent connections or links that may use a combination of wired and wireless technology.

UEs, UE1-UE4, may also use the wireless network 100 to access one or more other networks outside wireless network 100 such as a local area network “LAN” 130 including devices such as computing devices C1, C2, C3, C4 any of which may operate as servers, and which may communicate with each other via wired or wireless connections or a combination of wired and wireless technology. For this purpose, there may be a wired or wireless connection between either or both of AP1 and AP2 to LAN 130, which need not necessarily be via the internet 120.

Any of computing devices C1-C4 may operate within wireless network 100 as well as LAN 130. One such device C4 is shown having a wireless connection to AP2.

LAN 130 may be a wired network or it may another wireless network similar to network 100. Similarly wireless network 100 may also be termed a LAN.

Any of the UEs and servers S1 and S2 may comprise computing devices, examples of which are described in more detail below.

In the communication system of FIG. 1, information is exchanged between components in the form of data packets in which data is organized according to particular formats. An example of a particular format is the MAC frame format as prescribed by the 802.11 Standard, which is shown in FIG. 2. The 802.16 and 802.20 Standards prescribe similar frame formats.

The 802.11 Standard specifies four address fields in the MAC frame format. These fields are used to indicate the BSS identifier (BSSID), source address (SA), destination address (DA), transmitting STA address (TA) and receiving STA address (RA). Not all of the address fields are used in all frames.

A method according to some embodiments of the invention permits data to be transferred or associations to be established between or among UEs being served by the same AP, or one of a group of APs, for example within a particular location. In some embodiments, data may be transferred to or among UE's in a particular location or proximity to one or more AP's even without an address or identification of such UE being presented or available. For example, a method according to an embodiment of the invention may permit data to be transferred to for example all UE's that are in a proximity of an AP. This may be used for example to facilitate introductions between persons within the location, such as delegates in a conference or to transmit data such as a presentation slide to all of the persons in a lecture hall.

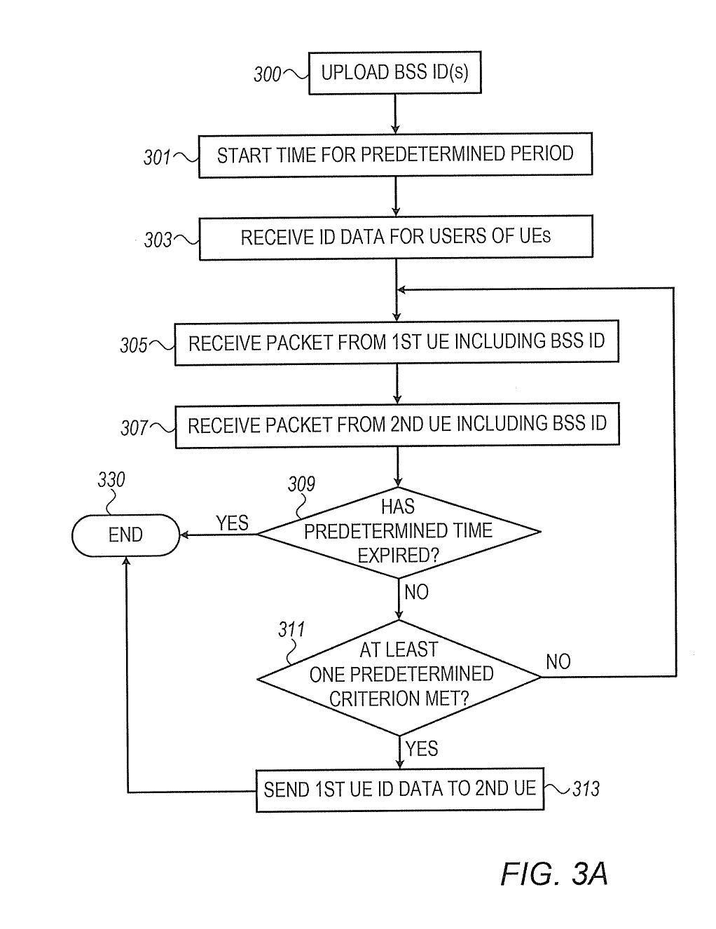

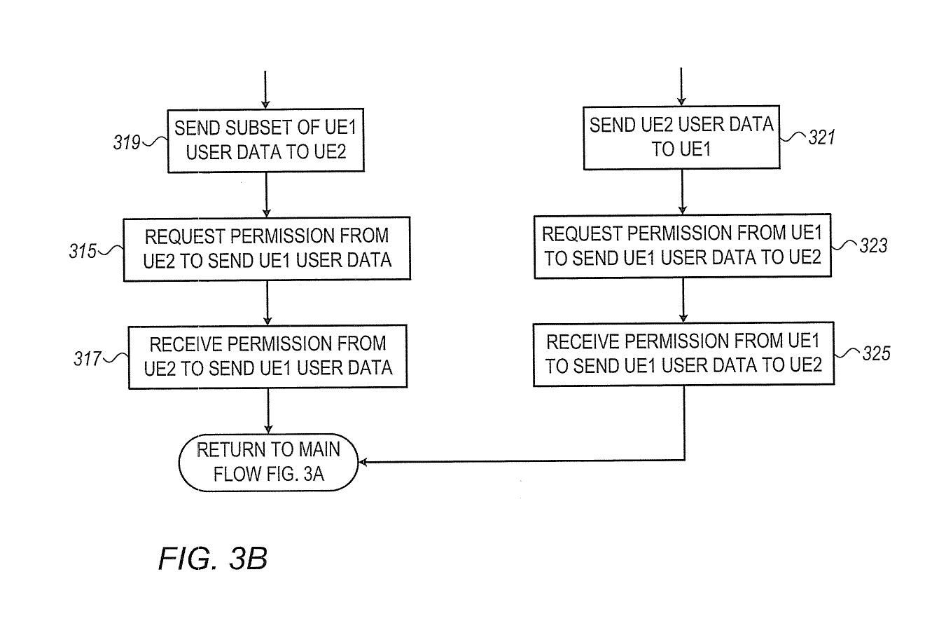

An example of one such method, according to an embodiment of the invention, will now be described with reference to FIGS. 3A and 3B. This method according to some embodiments of the invention is described as being implemented on server S1 but it may be implemented on any one or more computing devices at any part of a communication system such as that shown in FIG. 1.

It is assumed, for this example, that users of UE1-UE4 are among 100 delegates at a conference and UEs for the other delegates are not shown for the sake of clarity. Assume also that AP1 and AP2 are among a larger number of APs serving UEs for the 100 delegates and the other APs are not shown for the sake of clarity. In this example, a method according to an embodiment of the invention is to be used to introduce the user of UE1, Jane, to the user of UE2, Tom.

Upon registration for a conference, delegates are often asked to provide registration data such as contact details. This may be done ahead of the conference taking place, for example before users of UE1-UE4 are present at the conference and their UEs are being served by either of AP1 and AP2. Therefore, this registration data may be provided by users using UE1-UE4 or other equipment. The registration data may be held at a server outside the wireless network 100, such as server S1. According to other embodiments of the invention, the registration data may be provided by delegates on arrival at the conference, for example using their UEs. Either way the data may be held on a server such as S1 or a server or other computing device within any part of the communication system of FIG. 1, and not necessarily within the range of wireless network 100.

The registration data may be in a particular format such as a form or template completed by each delegate and may for example include for example a photograph of each delegate. Thus FIG. 1 schematically indicates forms F1 through F100 held at server S1. The registration data may include data enabling delegates to be contacted using UEs that they will take to the conference. Thus, if Jane's UE at the conference will be her cellular telephone, her user registration or identification data may include her cellular telephone number as a result of which she can receive short message service (SMS) messages or take voice calls. Tom may take only a tablet and no cellular telephone to the conference by which he can be contacted via email. Thus, the user identification data for Tom may include an email address. All or some of the UE's that are in proximity of an AP that is serving the conference hall may receive data from for example server S1, even though an organizer of the conference may not be aware of the identity or addresses of such UE.

FIG. 3A shows a method according to some embodiments of the invention that may be implemented in server S1 to facilitate sharing of user identification data based on location, e.g., wireless or AP association. According to some embodiments of the invention, a decision as to whether data received from one UE should be delivered, e.g., transmitted, to another is made based on whether they are being served by the same AP or group of APs. Two non-limiting examples of groups of APs may be AP1 and AP2, or all the APs serving the 100 delegates at the conference. Thus, the first operation 300 indicated in FIG. 3 is to upload a unique identifier, e.g., BSSID, for each of the one or more APs for which served UEs are to be permitted or allowed to receive user identification data. These may be maintained, for example stored in memory, at server S1. Any method of uploading may be used. The uploading of the BSSIDs may be a manual operation, for example performed on behalf of the conference organizer. According to other embodiments, the uploading may be from another computing device. If information is to be shared only amongst UEs being served by the same AP, operation 300 may not be necessary.

The decision or determination as to whether user identification data from one UE may be transmitted to another may be made at a device such as server S1 which may be outside the coverage of the APs. Therefore, it may be desirable for permission to transmit user identification data, such as may be granted by server S1 or any of the UEs, to be time limited. Thus, the next operation 301 shown in FIG. 3A is to start a timer for a predetermined period or duration of time. This need not be the first operation in the flow of FIG. 3A and may occur at any time before a further operation determining whether the predetermined time has lapsed.

The next operation 303 shown in FIG. 3A is the reception of identification data of a user of at least a first UE, e.g., Jane, the user of UE1. This may be part of an initial registration process as described above and therefore operation 303 may include receiving registration data for all 100 delegates including Tom, user of UE2, which includes delegate identification data. The delegate registration or identification data may be received in packet format via a wireless network in which case it may include a unique AP identifier, e.g., BSSID for the device from which it was transmitted. The initial registration data need not be received in packet format and may not include a BSSID. For example it could be manually input into server S1. It should be noted that depending on how or when this data is received, it may include a unique identifier of AP1 or AP2 or any other AP that is serving delegates at the conference.

Operations 305 and 307 in FIG. 3A indicate the reception of packets from first and second UEs, e.g., UE1 and UE2, respectively, each of which includes a unique identifier of an AP, such as BSSID, which may or may not identify AP1 or AP2 depending on the current location of UE1 and UE2. It will be appreciated that operations 305 and 307, or at least the first instance of operations 305 and 307, may occur as part of operation 301 when users provide their registration or identification data. Alternatively, instances of operations 305 and 307 may occur separately from operation 301.

Next, at operation 309 it may be determined whether the predetermined time has expired. If it has, the process ends at operation 330. If it has not, the process continues to operation 311.

At operation 311, a decision or determination may be made as to whether the AP unique identifiers, e.g., BSSIDs, received in packets from the first and second UEs, e.g., UE1 and UE2, meet at least one predetermined criterion or test. The at least one predetermined criterion or test may be required for permission to be granted for user identification data to be transmitted, received, shared or exchanged among UEs, and according to some embodiments of the invention it is based on location, or wireless association. According to some embodiments of the invention, a criterion to be met is identity of AP unique identification. In such a case, permission is granted only if the AP unique identification, e.g., BSSID, is identical in the packets received from the first and second UEs, e.g., UE1 and UE2, indicating that both UEs are in the geographical region or location covered by the same AP. According to other embodiments of the invention, the permission is based on a larger location or region, such as for example an area that is within reception/transmission distance of an AP such as a room, conference hall or other area, and the at least one predetermined criterion is that AP unique identifiers in packets from UE1 and UE2 are both in a list of identifiers maintained or stored (e.g., in a memory) at the server S1 as a result of operation 300. Thus, operation 311 may comprise comparing AP unique identifiers in received packets with AP unique identifiers received in packets from one or more other UEs of with AP unique identifiers maintained in a list.

In addition to the foregoing, the unique AP identifiers or other received packets may be required to meet other criteria such as indicating one of a set of predetermined network identifiers, inclusion of certain content such as a hashtag.

If it is determined or decided at operation 311 that the at least one predetermined criterion is not met, then operations 305 and 307 may be repeated or iterated until either the one or more criteria are met or the time period has expired.

If it is determined or decided at operation 311 that the at least one predetermined criterion is met, then according to some embodiments of the invention the flow proceeds to operation 313 where, for example in response to the determination at operation 309, the server transmits the user identification data of the first UE to the second UE. For example, UE1 user identification data to UE2 whereby Tom will receive identification data relating to Jane, so that for example, Tom can send a message to Jane without knowing for example a phone number or email address of Jane. For example, a picture or photo of Jane may appear on Tom's screen when Jane enters a room and her device is served by the same AP as is serving Tom, and Tom may then click on the picture on his screen and send a message to Jane and automatically get access to Jane. This is possible because the server can determine the address of UE2 from the MAC frame in the packet received from UE2 at operation 303 or 307. Instead of the server sending, e.g., transmitting, the UE1 user identification data, the server may grant permission for another device to send or transmit UE1 user identification data to UE2. Such grant may for example be performed at a server where a signal may be transmitted by for example a user or moderator, allowing a particular device to transmit data, voice or video that may be accessible to all UE that are in association with the AP. For example, the server may enable the user of UE1, Jane, to send her identification data directly to UE2, for example by transmitting or otherwise sending to UE1 the address of UE2.

In the example of use at a conference, the flow of FIG. 3 may operate in parallel or concurrently, or substantially at the same time for all users in the conference whereby all of them are able to receive each other's identification data based on the fact that their UEs are being served by the same AP or APs in a defined group. A group of APs may be defined by maintaining a list of AP unique identifiers. Thus, embodiments of the invention provide a mechanism by which people in a room or other area defined by AP identification can wirelessly introduce themselves to each other. The introduction can be made by the pre-completed templates or forms being sent to everyone whose UE is served by one or more APs.

According to some embodiments of the invention, prior to user identification data for one UE being transmitted to another, permission or consent is requested from the user of the UE that is to receive the user identification data. According to other embodiments of the invention, the permission or consent may be granted in the other direction, for example prior to user identification data for one UE being transmitted to another, permission is requested from the user whose identification data is to be transmitted.

FIG. 3B shows optional additional operations that may take place between operations 311 and 313 of FIG. 3A, in two separate flows shown on the right and left of the figure. Referring firstly to the left flow illustrated in FIG. 3B, following a yes determination at operation 311 in FIG. 3A, at operation 315 shown as the second operation, permission is requested from the user of UE2 to send to it identification data relating to the user of UE1. This may be done using any known messaging protocol such as SMS, or an instant messaging service such as the Instagram or Videogram services. Thus, for example, Tom can decline to accept identification data for Jane. According to this embodiment of the invention, only if permission is received from UE2 at operation 317 is user data for UE1 permitted or allowed to be transmitted to UE2.

The permission received at operation 317 may apply to all UEs that meet the one or more predetermined criteria applied in operation 311. According to other embodiments of the invention, permission granted at operation 317 may apply to a subset of UEs for which user identification data has been provided at operation 303 of FIG. 3A. To enable Tom the user of UE2 to choose between users for whom he would like to receive user identification data, Tom and other users of UEs might be provided with a subset of the user identification data received at operation 303, for example at operation 319 preceding operation 315 in FIG. 3B. This subset of user identification data might comprise for example a photograph of each of the users. Thus, for example, at operation 319, Tom might be presented with a photograph of the users of UEs that are served by the same AP as Tom's UE or an AP in the same predetermined group as Tom's UE. Tom may then choose, for example by a tick box operation, for which of the users he would like to receive more user identification data. The granting of permission can be used to ensure that a user, e.g., conference delegate, does not receive unwelcome personal information. Thus, Tom can decline to receive information identifying Jane.

Conversely, according to some embodiments of the invention, as noted above, the permission may be granted in the other direction, and an example of this is shown in the flow on the right of FIG. 3B. For example, permission may be requested from one or more users for their identification data to be transmitted to other UEs. This could be used to enable Jane to exercise some control over how her user identification data is shared with others. As with the flow on the left of FIG. 3B, the permission may be general or it may be specific to selected other users. For the example of specific permission, in operation 321 data relating to the user of UE2 is transmitted to UE1. This might again be a subset of the user data received at operation 303, especially if, for example, UE2 user also wishes to control how his identification data is shared. Then, in operation 323, permission may be requested from UE1 to send UE1 user identification data to UE2, and at operation 325 permission may be received to send UE1 user identification data to UE2. In some embodiments, such permitted access is granted only during the pre-determined time, such as a period when both UE1 and UE2 are being serviced by the same AP or within some period of time thereafter.

Some embodiments of the invention may require permission from both UEs before user identification for one UE is transmitted to another. Other embodiments of the invention may require permission from only one.

Some embodiments of the invention, such as those described with reference to FIGS. 3A and 3B, may be used to facilitate person to person networking. Consider the example in which a user, e.g., Jane, is presented with photographs of other users with whom she might make contact. She might use these to identify someone, e.g., Tom, who she has seen but cannot easily reach, for example because there are a large number of people between them. They may be at opposite ends of a row in a lecture theatre. Jane, optionally with Tom's permission, can send her personal identification data to Tom, and with that Tom can if he wishes arrange to meet her. The problem of the two of them missing each other in a crowd may be avoided.

In alternative embodiments of the invention, for example for sharing the kinds of information discussed in connection with FIGS. 3A and 3B, instead of UE1 and UE2 sending packets to server S1, the server S1 may query which UEs are being served by the APs for which it has BSSIDs from operation 300. This may be achieved using suitable logic associated with the APs so that they will respond to a query from server S1 with this information. In that case, it is advantageous if the registration data includes data uniquely identifying a UE for each delegate that the delegate will use at the conference. In other alternative embodiments of the invention, instead of UE1 and UE2 sending packets to the server S1, which may have to be addressed, the APs could be configured to to route packets received from all served UEs, or copies of all packets received from all served UEs, to server S1. In both of these examples, operation 311 may not be necessary. For example, the UEs may be a self-selected group of UEs that meet the one or more predetermined criteria.

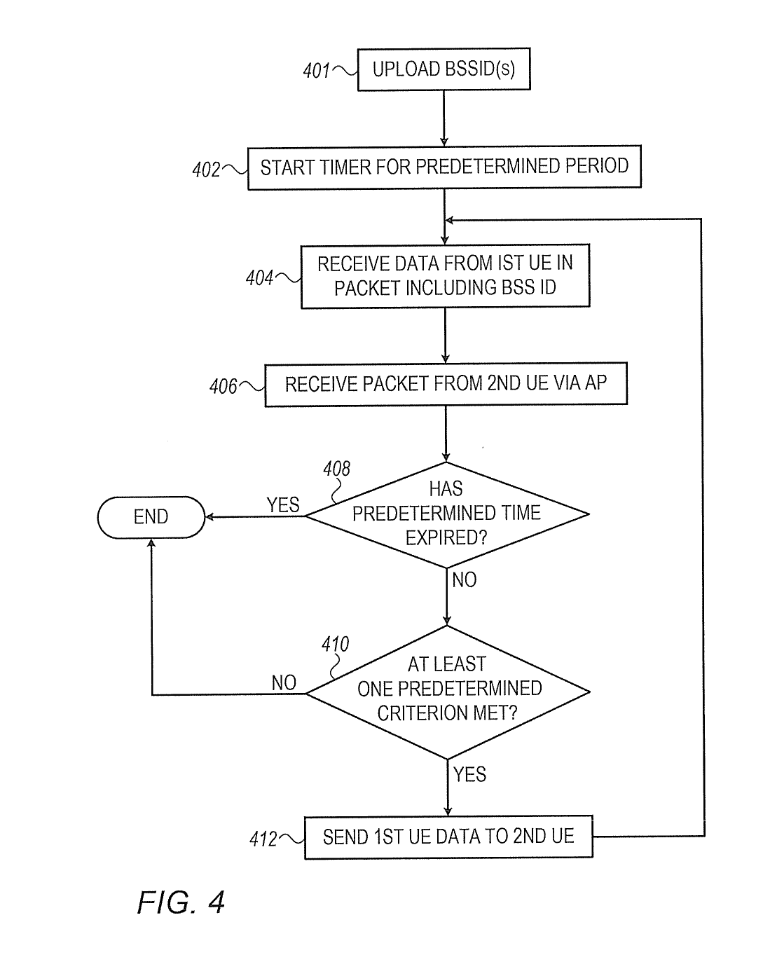

Other methods according to some embodiments of the invention permit other kinds of information to be shared amongst UEs served by the same AP or defined group of APs, not necessarily UE user identification information. An example of one such other method according to some embodiments of the invention will now be described with reference to FIG. 4. In this method, according to some embodiments of the invention, data from a first UE may be shared with all of the other UEs that are being served by the same AP or defined group of APs. The method according to some embodiments of the invention may be implemented in a computing device that is associated with the AP or group of APs. The computing device may be integrated into an AP or an AP comprising a computing device may be configured to implement methods according to some embodiments of the invention. FIG. 1 shows a computing device C4 that may be associated with AP1 and AP2. Each of AP1 and AP2 may be connected to C4 via a wired connection that is not part of the wireless network 100. C4 may be remote from AP1 and AP2 in any other part of the communications network shown in FIG. 1. As illustrated in FIG. 1, C4 operates within LAN 130. Either of servers S1 and S2 could perform the functions of computing device C4. It may be useful for AP1 and AP2 to communicate with a device performing the functions of C4 using a different protocol from that used for communication with served UEs.

Computing device C4 in this embodiment may have access to the internet 120, and for this it may have a wireless connection to one of the APs in the wireless network 100. This is shown by the dotted line joining C4 and AP2, whereby C4 is another UE served by AP2. Thus, any of the UEs served by AP1 or AP2 can communicate with C4 via the internet 120.

AP1 and AP2, for the purpose of some embodiments of the invention, may be configured, for example by suitable programming of their baseband processors, to route packets received from all served UEs, or copies of all packets received from all served UEs, to computing device C4. According to some embodiments of the invention, this may be done only with the permission of the served UEs. This permission may be provided for example on registration with the wireless network 100 and is simply for the purpose of identifying to C4 the UEs that are served by AP1 and AP2.

Assume that the user of UE1 wishes to send information to all other users being served by AP1 or AP2. UE1 may send the information to computing device C4. Device C4 has the addresses for all other UEs served by AP1 and AP2 and may be configured to send the information received from UE1 to all of UE2, UE3 and UE4.

This embodiment of the invention may be used for example to distribute information in a lecture or other presentation situation. As with the example of FIGS. 3A and 3B, in a practical embodiment, there may be 100 UEs served by more than two APs. It is possible for all of the APs to route packets to C4 and for C4 to share with all of the served APs information received from, e.g., UE1, which may belong to the lecturer or presenter.

Computing device C4 may be configured to distribute information received from more than one UE to all other UEs being served by the same AP or group of APs.

According to some embodiments of the invention, computing device C4 may be associated with APs arranged over a wide geographical area, and may be configured to distribute information only to UEs served by a subset of those APs. For example, C4 may be associated with all APs on a university campus, and may distribute information based on the AP unique identifier found in packets received from UEs.

It should be noted that the delivery or transmission of information from UE1 to other UEs may not be via network 100 and therefore for some embodiments of the invention the sending of information may be time limited, e.g., to the duration of a lecture.

Some embodiments of the invention may include a method for identifying from a packet transmitted by a first UE, that such UE is receiving at least one packet from an AP during a first period. An embodiment of the method may proceed to identify from a packet transmitted by a second UE, that such second UE is receiving at packets from the same AP during the same period. A server or other controller may allow during such period the UEs to transmit to and receive data from each other, for example if one or both of the UE's issue a signal that is received by for example a server or other controller that indicates a consent to transmit data to the other UE.

A computing device distributing information according to embodiments of the invention, such as device C4 in FIG. 1, may perform the operations shown in the flow of FIG. 4.

The flow of FIG. 4 may commence with the uploading, at operation 400, of a unique identifier for each AP for which users of served UEs may receive information or data. This is may be done similarly to operation 300 in FIG. 3A. The unique identifier may be for example BSSID. Identifiers for any number of APs including only one may be uploaded in operation 400. These unique identifiers may be maintained, for example stored in memory, at computing device C4. Any method of uploading may be used. According to some embodiments of the invention, the uploading of the BSSIDs may be a manual operation, for example performed on behalf of a lecture organizer. According to other embodiments, the uploading may be from another computing device. Operation 400 may not be necessary, for example if the computing device performing the operations of FIG. 4 is only receiving packets from APs whose served UEs are to receive data in the manner to be described below. The uploading of AP unique identifiers is useful to distinguish UEs to which data is to be transmitted from UEs to which data is not to be transmitted.

Operation 402 in the flow of FIG. 4 is the starting of a clock or timer to begin timing a predetermined period. This is an optional operation useful in various possible scenarios. For example, suppose the user of UE1 wishes to distribute information among UEs served by a group of APs. The user, e.g., Jane, might permit or allow all data transmitted from her device to be forwarded to those UEs so that she does not have to determine any particular criteria for the sending of data. In that case, Jane might require that the transmitting from C4 be time limited. For example, if she is a lecturer, the forwarding or onward transmission might be for the duration of her lecture. To avoid irrelevant data being transmitted to the UEs, Jane might disable certain applications on her UE for the duration of the lecture. Thus, the starting of a timer at operation 401, according to some embodiments of the invention, may be in response to a message from a particular UE such as UE1. According to other embodiments, it may take place at another time in the flow, in other words the operations may be performed in a different order.

At operation 404 data is received from a first UE, e.g., UE1. This may be in packet form and at least one of the packets may include a unique identifier of AP1 serving UE1. At operation 406, a packet is received from a second UE, e.g., UE2, including a unique identifier for AP2 serving the second UE. At operation 406, it is determined whether the predetermined time has expired, and if it has not, the data received from a UE in operation 404 may be transmitted to UE2. For example, computing device C4 may be configured only to transmit data received from UE1 to other UEs, or only to transmit data received from a subset of UEs to other UEs, in each case the other UEs being identified by location determined from AP association. Computing device C4 may determine whether data received from a UE is to be shared with other UEs in this way based on instructions received from UEs, for example included in packets received at operation 404. According to embodiments of the invention, the user of each UE for which data is to be distributed to other UEs may impose limits or criteria on the kind of information that may be shared. This may be a time limitation as noted above or it may be a limitation to data in a certain format, e.g. PowerPoint slides only, or any other limitation. Thus, at operation 404, C4 may be instructed as to what scope of information transmitted from a UE may be transmitted or otherwise forwarded to other UEs.

As illustrated, operation 404 refers to only one UE, but methods according to some embodiments of the invention may include the receiving of information for distribution from multiple UEs in operation 404 or instances of operation 404 running in parallel.

According to some embodiments of the invention, computing device C4 may receive only packets from UEs with whom information or data received in operation 404 is to be shared. For example, a method according to an embodiment of the invention may be used to share all data received from UE1 within a particular time period with all UEs served by or associated with AP1 and AP2, and computing device C4 may receive packets only from AP1 and AP2. If that is the case, if it is determined at operation 408 that the predetermined time period has not expired, the flow may continue to operation 412 in which data received from UE1 is transmitted to UE2.

According to other embodiments of the invention, computing device C4 may receive packets from UEs via multiple APs and may be configured to send data received from UE1 only to UEs served by a subset of the APs via which it is receiving packets. Thus, according to some embodiments of the invention, a determination is made at operation 410 whether at least one predetermined criterion is met. Data may be sent from UE1 to UE2 in response to the determination that the at least one criterion is met, e.g., a positive determination. The predetermined criterion may include that the unique identifier of the AP in a packet received from a UE at operation 406 matches the unique identifier of the AP in a packet received from a UE at operation 404. In that case operation 401 may not be necessary. Alternatively, the predetermined criterion may be that the unique identifier of the AP in a packet received from a UE at operation 406 matches one of the unique AP identifiers uploaded in operation 401.

The flow of FIG. 4 may continue with repetitions or iterations of some or all of operations 404 to 410 until the predetermined time or period has expired, in which case the flow ends at operation 420.

It will be appreciated that not all of operations 404 to 410 need to be repeated for each time data is transmitted from UE1 to UE2. For example, a batch of data may be transmitted in operation 412 rather than an individual packet. Also, operation 410 may be performed only for the first instance of receiving a packet from a particular UE, following which data is transmitted to that UE for as long as it continues to be served by the same AP, optionally limited to the predetermined time.

It will be appreciated that the embodiments of the invention described with reference to FIGS. 3A, 3B and 4 are not mutually exclusive and may be combined in various ways. For example, the embodiments of FIGS. 3A and 3B are not limited to personal information and may be used to distribute other information. This other information might be lecture material to name just one example. Thus, instead of personal information being received at operation 303, the information could be lecture material.

According to some embodiments of the invention, instead of information being shared by sending data received from one UE to another UE, information may be shared between UE users in other ways. One example is the display of information received from served UEs.

Thus, according to some embodiments of the invention, packets are received from a first user equipment “UE”, for example at a computing device such as device C4. The packets may include information and an identifier of a wireless access point “AP” supporting said first UE. If said identifier meets one or more predetermined criteria then, for example in response to the receipt of the packet, the information may be displayed, or sent to another UE supported by said one or more APs, or both. If said identifier does not meet the one or more predetermined criteria, the information may not be sent or displayed. It may be ignored or processed in some other way.

A predetermined criterion may be that the AP is one of a predetermined group of APs. As explained above, a computing device implementing methods according to the invention may be configured in conjunction with one or more APs only to receive packets via one or more APs in the predetermined group. If that is the case, it may not be necessary to positively determine that the AP identifier meets the one or more predetermined criteria. In other embodiments of the invention, an operation may be included to check that the one or more predetermined criteria are met.

Thus, for example, computing device C4 may include a display 140 as is known in the art, an input device such as a keyboard or touchpad 150, a processor 160 and a memory 170. Packets received by computing device C4 from UEs may include data, such as but not limited to images, videos or text files, that may be displayed. A display associated with computing device C4 might be a large screen or projection (e.g., wall) display of the kind used at events to be viewed by large numbers of people, from students at a lecture to large scale events such as music festivals.

The display or screen may be of any kind, from the kind used in a room of any size to the kind used in a stadium event. Thus, some embodiments of the invention may be used to enable users of UEs to display data to others participating in an event, by displaying information received from those UEs. In some embodiments of the invention, an interactive display may be used. For example, a person in the room may capture an image write a text, or prepare a voice or audio comment to a moderator in the room. The moderator may view the image or message and decide that it should be shown or made available to everyone in the room. The moderator may pass the image message or audio to an embodiment of the invention so that the text, image or audio is made available to everyone in the room. For example, if a person in an audience wants to make a comment to a speaker, then rather than pass a microphone to the person in audience, a moderator could allow the person to speak into his cellular telephone or mobile device, and such speech could be made available to everyone in the room. In another embodiment, a moderator may use an embodiment to give everyone in a room access to a display or presentation, to a translation of a speech in any of a number of languages or to advertising made available to everyone in a room or space.

According to some such embodiments, information may be shared not only with UE users whose UEs are served by the same AP or APs in the same predetermined group, but also others in the vicinity of or in sight of a display, such as a display associated with computing device C4. This display may not be in the same geographical location as device C4 but may be controlled by it. These embodiments of the invention could be implemented to enable some or all users to send their images, e.g., holiday photographs, presentations, or other visual data to a collective display such as a large screen or projected display in a room or football arena, for example for an event such as a presentation, meeting, or any other happening event. An optional time limit for any such embodiment might be the duration of the event. In such embodiments of the invention, the information displayed may be restricted to information received from UEs served by predetermined APs. The fact that a UE is served by a particular AP provides some information as to its geographical location.

A user of an UE that has shared information according to embodiments of the invention may have the capability to remove information that is displayed, for example by the sending of a suitable message from UE to computing device C4.

Computing device C4 could be configured to implement administrator functions as part of any embodiment of the invention. This could be used, for example, to add or remove information that is displayed, such as images and comments, or to adjust data to be displayed for appearance preferences and filtering. Some or all of these functions may be implemented automatically. Some or all of these functions may be implemented in response to user input, for example from a user identified to have administrator status.

According to some embodiments of the invention, the administration function may be able to override an image flow. For example this might be for the purpose of displaying an advertisement or any other information that may be designated to have priority over information received from UEs. Such higher priority information may have priority over some or all of the information received from UEs. This may for example occur during a presentation. Thus, some embodiments of the invention may comprise prioritizing information to be displayed including said information received from said first UE and other information, and displaying information according to allocated priority.

Some embodiments of the invention may use an administrator or other control function to devise a hierarchy or other prioritization rules for determining which of received information is to be sent to one or more other UEs or displayed or both.

According to some embodiments of the invention, an information display may be controlled, for example by computing device C4, to “flip” or alternate between displays or displayed images, for example between advertising (or any other information) and information received from defined served UEs, so that all or part of information displayed is changed for different information.

It will be appreciated from the foregoing that information for display may be received from multiple sources at various times, for example within a predetermined period. The manner in which such information is displayed, such as but not limited to size and duration, as well as prioritization as discussed above, may be controlled, for example according to predetermined rules.

Any control of how information is displayed may be automatic, for example by means of a suitable algorithm, or manual, for example via a user input device associated with a computing device controlling the display of information.

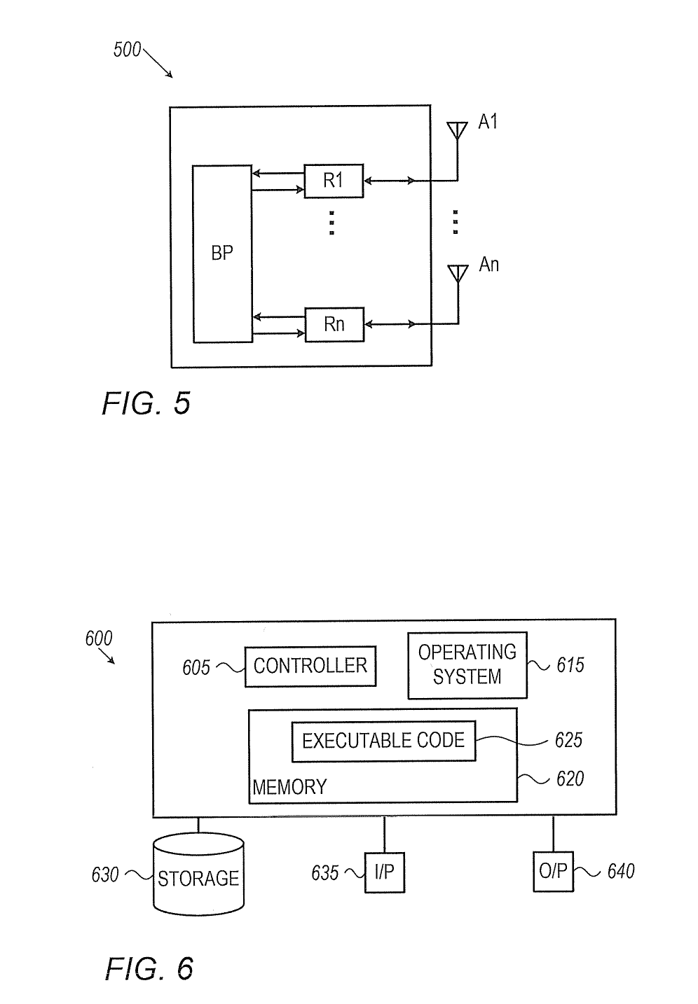

FIG. 5 is a schematic diagram of an AP such as may be used in some embodiments of the invention. Other or different components may be used. The illustrated AP 500 comprises multiple antennas A1-An each having a respective radio circuit R1-Rn and a baseband processor BP. The radio circuits R1-Rn perform various operations on signals received from the antennas A1 optionally including filtering and amplification prior to outputting them to the baseband processor for processing. Similarly the radio circuits R1-Rn perform operations on signals output from the baseband processor BP for transmission via the antennas A1-An.

The UEs and servers shown schematically in FIG. 1 may all comprise computing devices of one kind or another. FIG. 6 shows a schematic diagram of a computing device 600 showing components that may be included in any of UE1-UE4, C1-C4 and S1, S2. Other or different components may be used. Computing device 600 may include a controller 605 that may be, for example, a computer central processing unit processor (CPU), a chip or any suitable computing or computational device, an operating system 615, a memory 620, a storage 630, one or more input devices 635 and one or more output devices 640.

Controller 605 may be configured to carry out methods according to embodiments of the invention. For example, controller 605 may be connected to memory 620 storing software or instructions that when executed by controller 605 cause controller 605 to carry out method according to some embodiments of the present invention.

Operating system 615 may be or may include any code segment designed and/or configured to perform tasks involving coordination, scheduling, arbitration, supervising, controlling or otherwise managing operation of computing device 600, for example, scheduling execution of programs. Operating system 615 may be a commercial operating system. Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. In one embodiment, memory 620 is a non-transitory processor-readable storage medium that stores instructions and the instructions are executed by controller 605. Memory 620 may be or may include more than one possibly different memory units.

Executable code 625 may be any executable code, e.g., an application, a program, a process, task or script. Executable code 625 may be executed by controller 605 possibly under control of operating system 615. For example, executable code 625 may be an application that receives an indication of a location of an object of interest, retrieve from a database a set of MAC addresses used by communication devices present at the indicated location and associates a MAC address with the object of interest, e.g., as described herein.

Where applicable, executable code 625 may carry out operations described herein in real-time. In some embodiments, more than one computing device 600 may be used in place of any of the computing devices, UEs or servers shown in FIG. 1. For example, one or more computing devices that include components similar to those included in computing device 600 may be connected to a network and used as a system.

Storage 630 may be or may include, for example, a hard disk drive, a Compact Disk (CD) drive, a CD-Recordable (CD-R) drive, a universal serial bus (USB) device or other suitable removable and/or fixed storage unit. In some embodiments, some of the components shown in FIG. 6 may be omitted. For example, memory 620 may be a non-volatile memory having the storage capacity of storage 630. Accordingly, although shown as a separate component, storage 630 may be embedded or included in memory 620.

Input devices 635 may be or may include a mouse, a keyboard, a touch screen or pad or any suitable input device. It will be recognized that any suitable number of input devices may be operatively connected to computing device 600 as shown by block 635. Output devices 640 may include one or more displays, speakers and/or any other suitable output devices. It will be recognized that any suitable number of output devices may be operatively connected to computing device 600 as shown by block 640. Any applicable input/output (I/O) devices may be connected to computing device 600 as shown by blocks 635 and 640. For example, a wired or wireless network interface card (NIC), a modern, printer or a universal serial bus (USB) device or external hard drive may be included in input devices 635 and/or output devices 640.

Some embodiments of the invention may include an article such as a computer or processor transitory or non-transitory readable medium, or a computer or processor transitory or non-transitory storage medium, such as for example a memory, a disk drive, or a USB flash memory, encoding, including or storing instructions, e.g., computer-executable instructions, which, when executed by a processor or controller, cause the processor or controller to carry out methods disclosed herein. For example, embodiments of the invention may comprise a storage medium such as memory 620, computer-executable instructions such as executable code 625 and a controller such as controller 605.

A system according to some embodiments of the invention may include components such as, but not limited to, a one or more central processing units (CPU), e.g., similar to controller 605, or any other suitable multi-purpose or specific processors or controllers, a one or more input units, a one or more output units, a one or more memory units, and a one or more storage units. An embodiment of system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method in a communication network comprising a plurality of user equipment “UEs” supported by one or more wireless access points “APs”, the method comprising:
receiving identification data for a user of first user equipment “UE”,
receiving a unique identifier of an AP serving the first UE;
receiving a unique identifier of an AP serving a second UE;
determining that the unique identifiers meet at least one predetermined criterion; and
permitting the identification data for the user of the first UE to be transmitted to the second UE.

2. The method of claim 1 wherein said at least one predetermined criterion is that the first and second unique AP identifiers match.

3. The method of claim 1 further comprising maintaining a list of AP unique identifiers, wherein said at least one predetermined criterion is that the first and second unique AP identifiers both match AP identifiers in said list.

4. The method of claim 1 wherein said permitting is performed only during a predetermined time period.

5. The method of claim 1 comprising, prior to said permitting, receiving permission to send the identification data for the user of the first UE to said second UE.

6. The method of claim 5 comprising requesting said permission from said second UE and receiving said permission from said second UE in response to said request.

7. The method of claim 6 comprising transmitting to said second UE a subset of the identification data for the user of the first UE to enable said permission from said second UE to be based on said subset of identification data.

8. The method of claim 5 comprising requesting said permission from said first mobile communication device and receiving said permission from said first UE in response to said request.

9. The method of claim 8 comprising receiving identification data for a user of said second UE and transmitting to said first UE at least a subset of the identification data for the user of the second UE to enable said permission from said first UE to be based on said at least a subset of identification data.

10. The method of claim 5 wherein said permission includes one or more restrictions on the nature of data permitted to be sent from the first communication device to the second mobile communication device.

11. The method of claim 5 wherein said permission is received from a UE other than the first and second mobile communication devices.

12. A method in a wireless communication network comprising a plurality of user equipment “UEs” supported by one or more wireless access points “APs”, the method comprising:
receiving from at least one first user equipment “UE” information and an identifier of a wireless access point “AP” supporting said first UE; and
if said identifier meets one or more predetermined criteria performing one or both of:
displaying the information and sending the information to at least one other UE supported by said one or more APs.

13. The method of claim 12 wherein said one or more predetermined criteria include the identifier identifying an AP in a predetermined group of APs.

14. The method of claim 12 further comprising determining that said identifier meets said one or more predetermined criteria.

15. The method of claim 12 further comprising:
receiving a packet from at least one second UE including an identifier of an AP supporting said second UE; and
determining that said identifiers meet at least one predetermined criterion;
wherein said sending comprises sending data from said first UE to said second UE.

16. The method of claim 12 wherein said displaying or sending or both are performed only if said identifier meets said one or more predetermined criteria during a predetermined time period.

17. The method of claim 12 wherein said displaying comprises displaying to users of other UEs, each of said other UEs being supported by an AP of which the identifier meets said at least one predetermined criterion.

18. The method of claim 12 comprising prioritizing information to be displayed including said information received from said first UE and other information, and displaying information according to allocated priority.

19. The method of claim 12 comprising alternating between the display of information received from one or more UEs for which the AP identifier meets said at least one predetermined criterion and the display of other information.

20. A method comprising:
identifying from a packet transmitted by a first UE, that said first UE is receiving at least one packet from an AP during a first period;
identifying from a packet transmitted by a second UE, that said second UE is receiving at least one packet from said AP during said first period;
allowing during said first period, said first UE to transmit to and receive data from said second UE; and
receiving from said second UE a signal indicating a consent to transmit said data to said second UE.
